(19) United States
(12) Patent Application Publication
(10) Pub. No.: US 2006/0036198 A1
(43) Pub. Date: Feb. 16, 2006

(54) Foot spa

(75) Inventors: Michael Cafaro, El Paso, TX (US); Ruben Enriquez, El Paso, TX (US)

Correspondence Address: VINSON & ELKINS, L.L.P., 1001 FANNIN STREET, 2300 FIRST CITY TOWER, HOUSTON, TX, 77002-6760, US

(73) Assignee: Helen of Troy Limited

(21) Appl. No.: 11/199,807

(22) Filed: Aug. 9, 2005

Related U.S. Application Data
(60) Provisional application No. 60/600,152, filed on Aug. 10, 2004.

(51) Int. Cl. A61H 35/00; A61H 33/00; A61H 15/02; A61H 23/02

(52) U.S. Cl. 601/16; 4/574.1; 4/546; 601/17; 601/158; 601/22; 601/70; 607/86

(57) ABSTRACT

A foot spa apparatus includes an adjustable foot rest for convenience in painting toenails, for example, and also includes a toenail dryer apparatus.

### PRIORITY

This application claims priority based upon U.S. Provisional Application Ser. No. 60/600,152, filed Aug. 10, 2004 and entitled “Foot Spa.”

### BACKGROUND OF THE INVENTION

Foot spas for relaxation and therapy of the feet of a user have been described in the art. Foot spas may include touch controls for various functions such as heating and circulation of the water in the spa reservoir. Described foot spas also include pedicure attachments in the top surfaces of the spa devices.

### SUMMARY

A preferred embodiment of the present disclosure is a footbath that includes a water reservoir and four conveniently placed toe touch switches for a combination of different settings. The switches may control various functions of the device, including but not limited to heat, bubbles, massage, fan, and waterjet. Some switches may also control two functions simultaneously, such as bubble/heat or massage/heat. One function may be selected, or any or all of the functions may be selected simultaneously in any combination for multiple functions.

Preferred devices include a wire heater routed and secured on the bottom of the water reservoir to maintain the temperature of the water, a motor with an eccentric weight on the end of a shaft to provide massage, a motor with an impeller to provide aeration through the bubble vents, a motor with impeller to provide water jets through the water jet inlet ports, and a motor with an impeller for drying toenails. It is understood that each of the motors is connected to, and controlled by the toe touch switches.

Preferred devices further include a pedicure feature for providing a pedicure to the soles of the feet of a user. The pedicure feature includes a motor and a plurality of attachments that are attachable to the motor drive such that the attachments spin when the motor is engaged. Any suitable attachments may be provided, including brushes, pumice stones, vibration nodes, massaging rollers, or spikes. The motor incorporates a pressure switch such that pressing on the attachment starts the motor. The motor is also preferably provided with a gear mechanism configured to cause the motor to stop if the attachment is depressed with excessive pressure.

Preferred devices may further include an adjustable footrest on top of the device in which the footrest may be locked in various positions to adjust the angle of the foot when a user is painting her toenails, for example. A pushbutton is preferably located on the side of the footrest for locking the footrest in the desired position.

A splashguard may also be provided on the top of the footbath device. The splashguard also may provide storage locations for attachments that are not in use.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a perspective view of a preferred embodiment.

### DETAILED DESCRIPTION

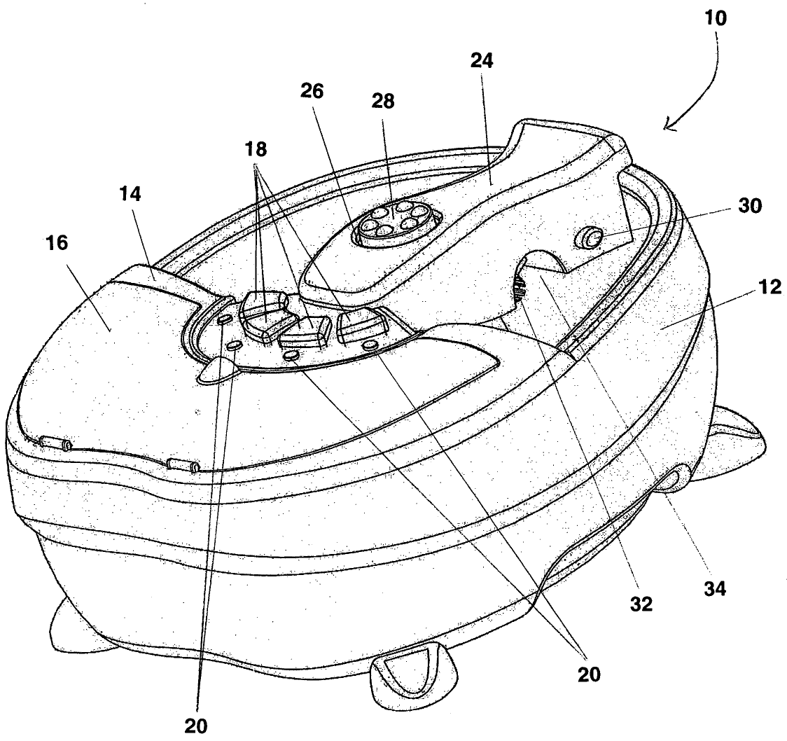

A preferred embodiment of the present disclosure is a foot bath apparatus 10 as shown in FIG. 1. The apparatus includes a housing 12 that forms a reservoir for holding the water or other liquids for submerging or soaking the feet of a user. The housing further includes a partial cover or splashguard 14, with a hinged top 16. The hinged top 16 covers a compartment that may be used for holding accessories that are not in use, and may include structures formed in the bottom of the compartment for holding the accessories.

The cover also provides a platform for the toe touch buttons 18 that activate the various functions of the device and the indicator lights 20 for each switch.

A footrest 24 and pedicure device 26 are located on the central portion of the device. The pedicure device includes a motor with a pressure responsive switch and provides a platform for various attachments 28, which snap on and off the spindle or axis of the pedicure motor. A massage roller attachment is shown in FIG. 1.

The footrest can be adjusted to various positions, preferably to three positions and locked in place. The footrest is locked in position using the pushbutton 30 located on the side of the footrest 24. In a preferred embodiment, the footrest also includes a nail dryer. The nail dryer includes a motor and fan 32, controlled by one of the toe touch switches. When the motor is activated, the fan blows air out a semicircular vent 34 on either side of the footrest and onto the painted toenails of the user.

While the apparatus and devices of this invention have been described in terms of preferred embodiments, it will be apparent to those of skill in the art that variations may be applied to the disclosed embodiments without departing from the concept, spirit and scope of the invention.

1. Foot spa apparatus comprising:
a footbath;
a position adjustable footrest attached to the foot spa; and
a toenail dryer adjacent the foot rest and comprising a motor and fan and configured to blow air on the toenails of a user.

2. The foot spa apparatus of claim 1, further comprising a plurality of toe touch switches for controlling features of the foot spa.

3. The foot spa apparatus of claim 2, wherein the features comprise heat, fan, bubbles, massage, waterjet or combinations thereof.

4. The foot spa of claim 1, further comprising a pedicure device, said device comprising a motor and interchangeable pedicure attachments.

5. The foot spa of claim 4, wherein the attachments are brushes, pumice stones, vibration nodes, massaging rollers, or spikes.

6. The foot spa of claim 1, wherein the foot rest is lockable in three positions.

7. The foot spa of claim 1, wherein the foot rest position adjustment mechanism comprises a push button located on the side of the foot rest.
